(19) United States
(12) Patent Application Publication
(10) Pub. No.: US 2020/0359288 A1
(43) Pub. Date: Nov. 12, 2020

(54) CELL RESELECTION METHOD AND DEVICE, AND COMPUTER STORAGE MEDIUM

(71) Applicant: GUANGDONG OPPO MOBILE TELECOMMUNICATIONS CORP., LTD., Dongguan (CN)

(72) Inventor: Hai TANG, Dongguan (CN)

(73) Assignee: GUANGDONG OPPO MOBILE TELECOMMUNICATIONS CORP., LTD., Dongguan (CN)

(21) Appl. No.: 16/941,421

(22) Filed: Jul. 28, 2020

Related U.S. Application Data
(63) Continuation of application No. PCT/CN2018/074440, filed on Jan. 29, 2018.

(51) Int. Cl. H04W 36/08; H04W 36/00; H04W 76/27; H04W 76/25

(52) U.S. Cl. CPC H04W 36/08; H04W 36/0061; H04W 36/0058; H04W 36/00835; H04W 76/27; H04W 76/25; H04W 36/0007

(57) ABSTRACT

Provided are a cell reselection method and device as well as a computer storage medium. The method includes: User Equipment (UE) acquires a cell reselection rule; and the UE selects a target cell based on the cell reselection rule and a network function supported by a neighbor cell and executes cell reselection based on the target cell.

### CROSS-REFERENCE TO RELATED APPLICATION

This application is a continuation of International Patent Application No. PCT/CN2018/074440, filed on Jan. 29, 2018, the content of which is hereby incorporated in its entirety.

### BACKGROUND

For meeting the demands of people on the rates, delays, high-speed mobility and energy efficiency of services as well as diversity and complexity of services in the future, the 3rd Generation Partnership Project (3GPP) has started researching and developing 5th Generation (5G).

Main application scenarios of 5G may include Enhance Mobile Broadband (eMBB), Ultra Reliable Low Latency Communication (URLLC) and massive Machine Type Communication (mMTC).

5G is also called New Radio (NR). During early deployment of NR, it is unlikely to implement complete NR coverage, so typical network coverage is a combination of Long Term Evolution (LTE) coverage and NR coverage. In addition, for protecting early investments of a mobile operating company in LTE, a working mode that is tight interworking between LTE and NR was proposed. An NR cell definitely may be deployed independently.

### SUMMARY

The disclosure relates to the technical field of wireless communications, and particularly to a cell reselection method and device and a computer storage medium.

A first aspect of the disclosure provides a cell reselection method, which may include the following operations.

UE acquires a cell reselection rule.

The UE selects a target cell based on the cell reselection rule and a network function supported by a neighbor cell and executes cell reselection based on the target cell.

A second of the disclosure provide a device for cell reselection, which may include a processor; a memory configured to store instructions executable by the processor; and a transmission device configured to send and receive data under control of the processor.

The processor is configured to:

acquire a cell reselection rule;

select a target cell based on the cell reselection rule and a network function supported by a neighbor cell; and

execute cell reselection based on the target cell.

### BRIEF DESCRIPTION OF THE DRAWINGS

The drawings described herein are adopted to provide a further understanding to the disclosure and form a part of the application. Schematic embodiments of the disclosure and descriptions thereof are adopted to explain the disclosure and not intended to form improper limits to the disclosure. In the drawings:

FIG. 1 is a flowchart of a cell reselection method according to an embodiment of the disclosure.

FIG. 2 is a structure composition diagram of a cell reselection device according to an embodiment of the disclosure.

FIG. 3 is a structure composition diagram of a computer device according to an embodiment of the disclosure.

### DETAILED DESCRIPTION

For making the characteristics and technical contents of the embodiments of the disclosure understood in more detail, implementation of the embodiments of the disclosure will be described below in combination with the drawings in detail. The drawings are only adopted for description as references and not intended to limit the embodiments of the disclosure.

In discussions about NR, a maximum channel bandwidth of each NR carrier is 100 MHz for a low frequency and 400 MHz for a high frequency, and the 100 MHz/400 MHz channel bandwidth is continuous. If User Equipment (UE) keeps working on a broadband carrier, power consumption of the UE is high, therefore, regulation of a Radio Frequency (RF) bandwidth of the UE according to a practical throughput of the UE is suggested.

When UE executes cell selection and cell reselection in an idle state, for meeting load balance in the idle state, a frequency-priority-based cell reselection policy is defined. In co-frequency cells or inter-frequency cells with the same priority, an R criterion is adopted for cell reselection, namely sequencing may be performed according to signal quality of the cells, and the cell with highest signal quality may be selected as a candidate reselection target cell. For a cell with a high frequency priority, the cell with the high frequency priority may be reselected when signal quality of the cell meets a certain threshold. For a cell with a low frequency priority, the cell with the low frequency priority may be reselected only when signal quality of a serving cell is lower than a certain threshold. Frequency-priority-based cell reselection may also be adopted for NR cells.

In an LTE cell, if the present LTE cell supports LTE-NR Dual Connection (DC) between LTE and NR, the LTE cell may broadcast 5G indication information through a system message (for example, a System Information Block 2 (SIB2)), and UE, when reading the 5G indication information, may display a 5G signal on a screen.

In an Evolved LTE (eLTE) cell, an Evolved Node B (eNB) may be connected to a 4th Generation (4G) Core Network (CN) (for example, an Evolved Packet Core (EPC)) and a 5G CN, and in such case, it may be broadcast through a system message that the CN that the eNB is connected to is the EPC, or the 5GCN, or the EPC and the 5G CN.

Based on this, if UE resides in an LTE cell (for example, for co-frequency deployment), all LTE cells have the same frequency priority. Cell reselection may be implemented according to an R criterion, namely the LTE cell broadcasting 5G indication information (called an LTE cell supporting 5G indication information hereinafter) and an eLTE cell have the same reselection priority, and cell reselection may be performed according to signal quality. However, in the LTE cell supporting 5G indication information and the eLTE cell, an operating company may expect the UE to preferably reside in a cell supporting a certain function. There has been no solution for how to implement cell reselection with an operating requirement of an operating company being met.

The technical solutions of the embodiments of the disclosure are mainly applied to a 5G system. However, the technical solutions of the embodiments of the disclosure are not limited to a 5G system, which instead may be applied to mobile communication systems of other types. A 5G system, as a main application scenario, will be described below.

1) An eMBB scenario: eMBB aims to enable a user to obtain multimedia content, service and data, and service requirements thereof increase rapidly. Since eMBB may be deployed in different scenarios, for example, a room, an urban area, a rural area and so on, and service capabilities and requirements thereof are greatly different, it is necessary to analyze a service in combination with a specific deployment scenario.

2) A URLLC scenario: typical applications of URLLC include industrial automation, power automation, remote medical operation, traffic safety guarantee and the like.

3) An mMTC scenario: typical characteristics of mMTC include high connection density, small data volume, delay-insensitive services, low cost and long service life of modules and the like.

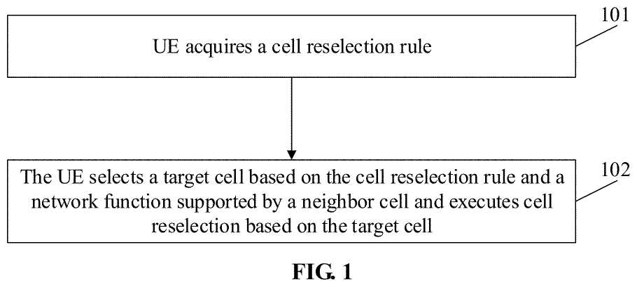

FIG. 1 is a flowchart of a cell reselection method according to an embodiment of the disclosure. As shown in FIG. 1, the cell reselection method includes the following operations.

In operation 101, UE acquires a cell reselection rule.

In the embodiments of the disclosure, the UE may be any device capable of communicating with a network, such as a mobile phone, a tablet computer, a notebook computer and a desktop computer.

In the embodiments of the disclosure, the UE may acquire the cell reselection rule through the following manners.

A first manner is: the UE acquires the cell reselection rule through a configuration of a protocol.

A second manner is: the UE acquires the cell reselection rule through a system message or locally pre-stored information or RRC signaling or NAS signaling.

In operation 102, the UE selects a target cell based on the cell reselection rule and a network function supported by a neighbor cell and executes cell reselection based on the target cell.

In the embodiments of the disclosure, the operation that the UE selects the target cell based on the cell reselection rule and the network function supported by the neighbor cell may specifically be implemented through the following manners.

Manner 1:

1) The UE acquires a system message broadcast by a first cell and determines based on the system message broadcast by the first cell that the first cell is a cell not supporting a target network function.

For example, the UE resides in a cell, acquires a system message broadcast by the cell and may determine the type of the cell based on the system message. For example, the cell may be an ordinary LTE cell, i.e., a non-5G indication cell (i.e., a cell of which a system message includes no 5G indication information), which is not an eLTE cell.

2) The UE performs neighbor cell measurement in the first cell.

3.1) In response to detecting by measurement that a second cell supports the target network function and signal quality of the second cell is higher than a first threshold, the second cell is determined as the target cell, the second cell being a co-frequency neighbor cell of the first cell.

In an implementation mode, the UE may acquire a system message broadcast by the neighbor cell and may determine whether the second cell supports the target network function based on the system message broadcast by the neighbor cell.

In another implementation mode, the UE may acquire the system message broadcast by the first cell and determine whether the second cell supports the target network function based on the system message broadcast by the first cell.

In the embodiments of the disclosure, the target network function may include at least one of:

a function of 5G indication information and a function of type information of a CN that a base station is connected to.

A 5G indication cell may have the function of 5G indication information, namely a system message of the 5G indication cell may include 5G indication information. An eLTE cell may have the function of type information of a CN that a base station is connected to, namely a system message of the eLTE cell may include type information (for example, an EPC, or a 5G CN, or the EPC and the 5G CN) of a CN that a base station is connected to.

3.2) In response to detecting by measurement that signal quality of a third cell with a high frequency priority is higher than a first threshold, the third cell is determined as the target cell, the third cell being an inter-frequency neighbor cell of the first cell.

It is to be understood that each threshold in the solution may be acquired through a system message broadcast by a cell.

Manner 2:

1) The cell reselection rule includes multiple reselection sub-rules, each reselection sub-rule corresponding to a priority; and the UE selects the reselection sub-rules for selecting the target cell according to a sequence from high to low priorities.

For example, a frequency priority rule may have a first class priority and a network function rule may have a second class priority. Or, the frequency priority rule may have a second class priority and the network function rule may have a first class priority.

2.1) Under the condition that the multiple reselection sub-rules include a first reselection sub-rule and a second reselection sub-rule, the first reselection sub-rule is a network-function-based reselection sub-rule, the second reselection sub-rule is a frequency-priority-based reselection sub-rule and the reselection sub-rule with the first class priority is the network-function-based reselection sub-rule, the following operations are executed:

the UE performs neighbor cell measurement in the first cell, the first cell not supporting the target network function;

in response to it is measured that the second cell supports the target network function and the signal quality of the second cell is higher than the first threshold, the second cell is determined as the target cell;

the second cell is a co-frequency neighbor cell or an inter-frequency neighbor cell of the first cell.

In an implementation mode, the UE may acquire the system message broadcast by the neighbor cell and determine whether the second cell supports the target network function based on the system message broadcast by the neighbor cell.

In another implementation mode, the UE may acquire the system message broadcast by the first cell and determine whether the second cell supports the target network function based on the system message broadcast by the first cell.

In the embodiments of the disclosure, the target network function may include at least one of:

a function of 5G indication information and a function of type information of a CN that a base station is connected to.

A 5G indication cell may have the function of 5G indication information, namely a system message of the 5G indication cell may include 5G indication information. An eLTE cell may have the function of type information of a CN that a base station is connected to, namely a system message of the eLTE cell may include type information (for example, an EPC, or a 5G CN, or the EPC and the 5G CN) of a CN that a base station is connected to.

2.2) Under the condition that the multiple reselection sub-rules include a first reselection sub-rule and a second reselection sub-rule, the first reselection sub-rule is a frequency-priority-based reselection sub-rule, the second reselection sub-rule is a network-function-based reselection sub-rule and the reselection sub-rule with the first class priority is the frequency-priority-based reselection sub-rule, the following operations are executed:

the UE performs neighbor cell measurement in the first cell;

in response to it is measured that the signal quality of the third cell with the high frequency priority is higher than the first threshold, the third cell is determined as the target cell;

the third cell is an inter-frequency neighbor cell of the first cell.

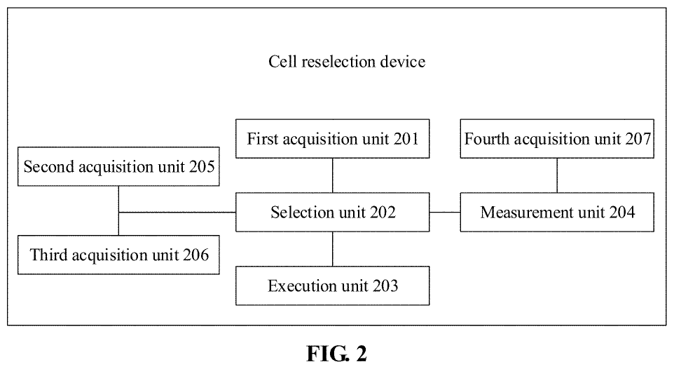

FIG. 2 is a structure composition diagram of a cell reselection device according to an embodiment of the disclosure. As shown in FIG. 2, the cell reselection device includes a first acquisition unit 201, a selection unit 202 and an execution unit 203.

The first acquisition unit 201 is configured to acquire a cell reselection rule.

The selection unit 202 is configured to select a target cell based on the cell reselection rule and a network function supported by a neighbor cell.

The execution unit 203 is configured to execute cell reselection based on the target cell.

In an implementation mode, the first acquisition unit 201 may be configured to acquire the cell reselection rule through a configuration of a protocol.

In an implementation mode, the device further may include a measurement unit 204.

The measurement unit 204 may be configured to perform neighbor cell measurement in a first cell.

The selection unit 202 may be configured to, in response to it is measured that a second cell supports a target network function and signal quality of the second cell is higher than a first threshold, determine the second cell as the target cell, the second cell being a co-frequency neighbor cell of the first cell.

In an implementation mode, the device further may include a second acquisition unit 205.

The second acquisition unit 205 may be configured to acquire a system message broadcast by the neighbor cell and determine whether the second cell supports the target network function based on the system message broadcast by the neighbor cell.

In an implementation mode, the device further may include a third acquisition unit 206.

The third acquisition unit 206 may be configured to acquire a system message broadcast by the first cell and determine whether the second cell supports the target network function based on the system message broadcast by the first cell.

In an implementation mode, the device further may include the measurement unit 204.

The measurement unit 204 may be configured to perform neighbor cell measurement in the first cell.

The selection unit 202 may be configured to, in response to it is measured that signal quality of a third cell with a high frequency priority is higher than the first threshold, determine the third cell as the target cell.

The third cell may be an inter-frequency neighbor cell of the first cell.

In an implementation mode, the device further may include a fourth acquisition unit 207.

The fourth acquisition unit 207 may be configured to acquire the system message broadcast by the first cell and determine based on the system message broadcast by the first cell that the first cell is a cell not supporting the target network function.

In an implementation mode, the target network function may include at least one of:

a function of 5G indication information and a function of type information of a CN that a base station is connected to.

In an implementation mode, the first acquisition unit 201 may be configured to acquire the cell reselection rule through a system message or locally pre-stored information or RRC signaling or NAS signaling.

In an implementation mode, the cell reselection rule may include multiple reselection sub-rules, each reselection sub-rule corresponding to a priority.

The selection unit 202 may be configured to select the reselection sub-rules for selecting the target cell according to a sequence from high to low priorities.

In an implementation mode, the multiple reselection sub-rules may include a first reselection sub-rule and a second reselection sub-rule, the first reselection sub-rule may be a network-function-based reselection sub-rule and the second reselection sub-rule may be a frequency-priority-based reselection sub-rule, the device may include the measurement unit 204.

The measurement unit 204 may be configured to perform neighbor cell measurement in the first cell, the first cell not supporting the target network function.

The selection unit 202 may be configured to, in response to it is measured that the second cell supports the target network function and the signal quality of the second cell is higher than the first threshold, determine the second cell as the target cell, the second cell being a co-frequency neighbor cell or an inter-frequency neighbor cell of the first cell.

In an implementation mode, the device further may include the second acquisition unit 205.

The second acquisition unit 205 may be configured to acquire the system message broadcast by the neighbor cell and determine whether the second cell supports the target network function based on the system message broadcast by the neighbor cell.

In an implementation mode, the device further may include the third acquisition unit 206.

The third acquisition unit 206 may be configured to acquire the system message broadcast by the first cell and determine whether the second cell supports the target network function based on the system message broadcast by the first cell.

In an implementation mode, the multiple reselection sub-rules may include the first reselection sub-rule and the second reselection sub-rule, the first reselection sub-rule may be a frequency-priority-based reselection sub-rule and the second reselection sub-rule may be a network-function-based reselection sub-rule, the device may include the measurement unit 204.

The measurement unit 204 may be configured to perform neighbor cell measurement in the first cell.

The selection unit 202 may be configured to, in response to it is measured that the signal quality of the third cell with the high frequency priority is higher than the first threshold, determine the third cell as the target cell, the third cell being an inter-frequency neighbor cell of the first cell.

In an implementation mode, the target network function may include at least one of:

a function of 5G indication information and a function of type information of a CN that a base station is connected to.

Those skilled in the art should know that functions realized by each unit in the cell reselection device shown in FIG. 2 can be understood with reference to related descriptions about the cell reselection method. The functions of each unit in the cell reselection device shown in FIG. 2 may be realized through a program running in a processor, and may also be realized through a specific logical circuit.

When being implemented in form of software functional module and sold or used as an independent product, the cell reselection device of the embodiments of the disclosure may also be stored in a computer-readable storage medium. Based on such an understanding, the technical solutions of the embodiments of the disclosure substantially or parts making contributions to the related arts may be embodied in form of software product, and the computer software product may be stored in a storage medium, including a plurality of instructions configured to enable a computer device (which may be a personal computer, a server, a network device or the like) to execute all or part of the method in each embodiment of the disclosure. The storage medium may include: various media capable of storing program codes such as a U disk, a mobile hard disk, a Read Only Memory (ROM), a magnetic disk or an optical disk. Therefore, the embodiments of the disclosure are not limited to any specific hardware and software combination.

Correspondingly, the embodiments of the disclosure also provide a computer storage medium, in which computer-executable instructions have been stored, the computer-executable instructions being executable by a processor to implement the cell reselection method of the embodiments of the disclosure.

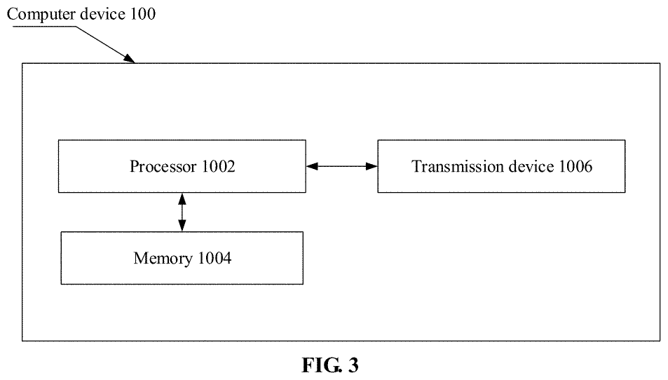

FIG. 3 is a structure diagram of a computer device according to an embodiment of the disclosure. The computer device may be any type of UE. As shown in FIG. 3, the computer device 100 may include: one or more (only one is illustrated in the figure) processors 1002 (the processor 1002 may include, but not limited to, a processing device such as a Micro Control Unit (MCU) or a Field Programmable Gate Array (FPGA)); a memory 1004 configured to store data; and a transmission device 1006 configured for a communication function. Those of ordinary skill in the art should know that the structure shown in FIG. 3 is only schematic and not intended to limit the structure of the electronic device. For example, the computer device 100 may further include components more or fewer than the components shown in FIG. 3 or has a configuration different from that shown in FIG. 3.

The memory 1004 may be configured to store a module and a software program of application software, which is for example, a program instruction/module corresponding to the method in the embodiments of the disclosure. The processor 1002 may run the software program and module stored in the memory 1004, thereby executing various functional applications and data processing, namely implementing the abovementioned method. The memory 1004 may include a high-speed random access memory or include a nonvolatile memory, for example, one or more magnetic storage devices, flash memories or other nonvolatile solid-state memories. In some examples, the memory 1004 may further include a memory arranged remotely relative to the processor 1002 and the remote memory may be connected to the computer device 100 through a network. An example of the network includes, but not limited to, the Internet, an intranet, a local area network, a mobile communication network and a combination thereof.

The transmission device 1006 is configured to receive or send data through a network. A specific example of the network may include a wireless network provided by a communication provider of the computer device 100. In an example, the transmission device 1006 includes a Network Interface Controller (NIC), which may be connected with another network device through a base station, thereby communicating with the Internet. In an example, the transmission device 1006 may be an RF module, configured to communicate with the Internet in a wireless manner.

In the technical solutions of the embodiments of the disclosure, UE may acquire a cell reselection rule; and the UE may select a target cell based on the cell reselection rule and a network function supported by a neighbor cell and may execute cell reselection based on the target cell. With adoption of the technical solutions of the embodiments of the disclosure, UE may select a target cell for reselection based on a network function and a cell reselection rule broadcast through a system message or a cell reselection rule specified in a protocol, so that the UE may adaptively implement cell reselection under control of a network side, and an operating requirement of an operating company can be met.

The technical solutions recorded in the embodiments of the disclosure may be freely combined without conflicts.

In some embodiments provided by the disclosure, it is to be understood that the disclosed method and intelligent device may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each functional unit in each embodiment of the disclosure may be integrated into a second processing unit. Each unit may serve as an independent unit and two or more than two units may be integrated into a unit. The integrated unit may be implemented in a hardware form and may also be implemented in form of hardware and software functional unit.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure.

1. A method for cell reselection, comprising:
acquiring, by User Equipment (UE), a cell reselection rule; and
selecting, by the UE, a target cell based on the cell reselection rule and a network function supported by a neighbor cell, and
executing, by the UE, cell reselection based on the target cell.

2. The method of claim 1, wherein acquiring, by the UE, the cell reselection rule comprises:
acquiring, by the UE, the cell reselection rule through a configuration of a protocol.

3. The method of claim 2, wherein selecting, by the UE, the target cell based on the cell reselection rule and the network function supported by the neighbor cell comprises:
performing, by the UE, neighbor cell measurement in a first cell; and
in response to it is measured that a second cell supports a target network function and signal quality of the second cell is higher than a first threshold, determining, by the UE, the second cell as the target cell,
wherein the second cell is a co-frequency neighbor cell of the first cell.

4. The method of claim 3, further comprising:
acquiring, by the UE, a system message broadcast by the neighbor cell, and
determining, by the UE, whether the second cell supports the target network function based on the system message broadcast by the neighbor cell;
or, the method further comprising:
acquiring, by the UE, a system message broadcast by the first cell; and
determining, by the UE, whether the second cell supports the target network function based on the system message broadcast by the first cell;
or, the method further comprising:
acquiring, by the UE, a system message broadcast by the first cell; and
determining, by the UE, based on the system message broadcast by the first cell that the first cell is a cell not supporting the target network function.

5. The method of claim 2, wherein selecting, by the UE, the target cell based on the cell reselection rule and the network function supported by the neighbor cell comprises:
performing, by the UE, neighbor cell measurement in a first cell; and
in response to it is measured that signal quality of a third cell with a high frequency priority is higher than a first threshold, determining, by the UE, the third cell as the target cell,
wherein the third cell is an inter-frequency neighbor cell of the first cell.

6. The method of claim 3, wherein the target network function comprises at least one of:
a function of 5th Generation (5G) indication information and a function of type information of a Core Network (CN) that a base station is connected to.

7. A device for cell reselection, comprising:
a processor;
a memory configured to store instructions executable by the processor; and
a transmission device configured to send and receive data under control of the processor;
wherein the processor is configured to:
control the transmission device to acquire a cell reselection rule;
select a target cell based on the cell reselection rule and a network function supported by a neighbor cell; and
execute cell reselection based on the target cell.

8. The device of claim 7, wherein the transmission device is configured to acquire the cell reselection rule through a configuration of a protocol.

9. The device of claim 8, wherein the processor is further configured to:
perform neighbor cell measurement in a first cell, and
in response to it is measured that a second cell supports a target network function and signal quality of the second cell is higher than a first threshold, determine the second cell as the target cell, the second cell being a co-frequency neighbor cell of the first cell.

10. The device of claim 9, wherein the processor is further configured to:
control the transmission device to acquire a system message broadcast by the neighbor cell, and determine whether the second cell supports the target network function based on the system message broadcast by the neighbor cell.

11. The device of claim 9, wherein the processor is further configured to:
control the transmission device to acquire a system message broadcast by the first cell, and determine whether the second cell supports the target network function based on the system message broadcast by the first cell.

12. The device of claim 8, wherein the processor is further configured to:
perform neighbor cell measurement in a first cell, and
in response to it is measured that signal quality of a third cell with a high frequency priority is higher than a first threshold, determine the third cell as the target cell, the third cell being an inter-frequency neighbor cell of the first cell.

13. The device of claim 9, wherein the processor is further configured to:
control the transmission device to acquire a system message broadcast by the first cell, and determine based on the system message broadcast by the first cell that the first cell is a cell not supporting the target network function.

14. The device of claim 7, wherein the transmission device is configured to acquire the cell reselection rule through a system message or locally pre-stored information or Radio Resource Control (RRC) signaling or Non-Access Stratum (NAS) signaling.

15. The device of claim 14, wherein the cell reselection rule comprises multiple reselection sub-rules, each reselection sub-rule corresponding to a priority; and
the processor is further configured to select the multiple reselection sub-rules according to a sequence from high to low priorities for selecting the target cell.

16. The device of claim 15, wherein the multiple reselection sub-rules comprise a first reselection sub-rule and a second reselection sub-rule, the first reselection sub-rule is a network-function-based reselection sub-rule and the second reselection sub-rule is a frequency-priority-based reselection sub-rule,
the processor is further configured to:
perform neighbor cell measurement in a first cell, the first cell not supporting a target network function; and
in response to it is measured that a second cell supports the target network function and signal quality of the second cell is higher than a first threshold, determine the second cell as the target cell, the second cell being a co-frequency neighbor cell or an inter-frequency neighbor cell of the first cell.

17. The device of claim 16, wherein the processor is further configured to:
control the transmission device to acquire a system message broadcast by the neighbor cell, and determine whether the second cell supports the target network function based on the system message broadcast by the neighbor cell.

18. The device of claim 16, wherein the processor is further configured to:
control the transmission device to acquire a system message broadcast by the first cell, and determine whether the second cell supports the target network function based on the system message broadcast by the first cell.

19. The device of claim 15, wherein the multiple reselection sub-rules comprise the first reselection sub-rule and a second reselection sub-rule, the first reselection sub-rule is a frequency-priority-based reselection sub-rule and the second reselection sub-rule is a network-function-based reselection sub-rule,
the processor is further configured to:
perform neighbor cell measurement in a first cell; and
in response to it is measured that signal quality of a third cell with a high frequency priority is higher than a first threshold, determine the third cell as the target cell, the third cell being an inter-frequency neighbor cell of the first cell.

20. The device of claim 25, wherein the target network function comprises at least one of:
a function of 5G indication information and a function of type information of a CN that a base station is connected to.
